(19) United States
(12) Patent Application Publication
(10) Pub. No.: US 2010/0027098 A1
(43) Pub. Date: Feb. 4, 2010

(54) ELECTROLYTE MATERIAL FOR ELECTRO-CONTROLLED DEVICE METHOD FOR MAKING THE SAME, ELECTRO-CONTROLLED DEVICE INCLUDING THE SAME AND METHOD FOR PRODUCING SAID DEVICE

(75) Inventors: Fabienne Piroux, La Plaine Saint-Denis (FR); Pascal Petit, Gagny (FR); Annabelle Andreau, Aachen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Glass France, Courbevoie (FR)

(21) Appl. No.: 12/519,228

(22) PCT Filed: Dec. 18, 2007
(86) PCT No.: PCT/FR2007/052553

§ 371 Date: Jul. 31, 2009

(30) Foreign Application Priority Data
Dec. 18, 2006 (FR) 0655610
Jun. 25, 2007 (FR) 0755985

(51) Int. Cl. G02F 1/153; H01G 9/025; B29D 11/00; B32B 37/00

(52) U.S. Cl. 359/270; 252/62.2; 264/2.7; 156/60; 359/265; 359/275

(57) ABSTRACT

The invention relates to an electrolyte material for an electrically-controllable device having variable optical/energy properties, characterized in that it comprises a self-supporting polymer matrix containing ionic fillers and a liquid for solubilizing said ionic fillers, said liquid not solubilizing said self-supporting polymer matrix, the latter being selected so as to provide a percolation path for said ionic fillers; to an electrically-controllable device having variable optical/energy properties, comprising such an electrolyte material; and to a method for fabricating such an electrically-controllable device, characterized in that the various layers thereof are assembled by calendering or lamination, optionally with heating.

The present invention relates to an electrolyte material for an electrically-controllable device, to its method of fabrication, to the electrically-controllable device comprising same, and to a method for fabricating said device.

Such an electrically-controllable device is said to have variable optical and/or energy properties. It can be defined in general as comprising the following stack of layers:

a first substrate having a glass function;

a first electronically conductive layer with associated current input;

an electroactive system;

a second electronically conductive layer with associated current input; and

a second substrate having a glass function.

Layered electroactive systems comprise two layers of electroactive material separated by an electrolyte, the electroactive material of at least one of the two layers being electrochromic. In the case in which both electroactive materials are electrochromic, they may be identical or different. In the case in which one of the electroactive materials is electrochromic and the other is not, the latter has the role of a counter-electrode not participating in the coloration and decoloration processes of the system. Under the action of an electric current, the ionic fillers of the electrolyte are inserted into one of the layers of electrochromic material and are stripped from the other layer of electrochromic material or from the counter-electrode to obtain a color contrast.

International application PCT WO 2005/008326 describes an active system obtained by the method consisting in:

taking a matrix of polyethylene oxide film, generally called PEO;

swelling this matrix in the monomer 3,4-ethylenedioxythiophene (EDOT);

polymerizing the EDOT to obtain a film of PEO on both sides of which is the electrochromic polymer poly (3,4-ethylenedioxythiophene) (PEDOT);

swelling the film thus treated in a solvent (such as propylene carbonate) in which a salt (such as lithium perchlorate) is dissolved.

This active system has the advantage of having mechanical strength, in other words, of being self-supporting.

However, as may be ascertained, the fabrication of the active system is complex, therefore difficult to implement industrially. Moreover, the contrast that can be obtained, that is the ratio of the light transmission in the decolored state/light transmission in the colored state, in the case of two identical electrochromic materials, is barely satisfactory, often fairly close to 2, and the system is generally rather dark, even in the decolored state, with light transmissions often below 40%, or even 25%.

Thus, the solution proposed by WO 2005/008326 is unsuitable for satisfactorily replacing the present solution, which is to use a gel electrolyte (see for example EP 0 880 189 B1; U.S. Pat. No. 7,038,828 B2).

When a gel electrolyte is used for the purpose of imparting strength to the electrolyte, a polymer PEDOT, polyaniline or polypyrrole is introduced, for example, into a “reservoir” zone between the two layers of electrochromic material, or between a layer of electrochromic material or a counter-electrode layer, each of the two layers in question being in contact with the electronically conductive layer (such as a transparent conductive oxide (TCO)). The gel electrolyte consists of a polymer, prepolymer (PMMA, PEO for example) or monomer in a mixture with a solvent and a solubilized salt, and after being placed in the “reservoir” zone of the electrically-controllable device, it may for example be heated to cause crosslinking of the polymer, prepolymer or a polymerization of the monomer.

Apart from the fact that it is not industrially easy to introduce the gel or a solution which is then gelled into the reservoir, the electrolyte materials described above are not self-supporting. This solution is not satisfactory for devices that may be large (such as glazing) which are used in a vertical position and in which the medium moves within the reservoir under its own weight, so that, if the two substrates are not sufficiently reinforced mechanically by a peripheral seal, there is a risk of an opening in the glazing due to the hydrostatic pressure that causes “bellying” of the glazing. Moreover, these gel electrolytes contain large quantities of solvent(s), which are liable to interact with the encapsulation material, incurring the risk of causing or promoting a detachment of the two substrates from the glazing.

A mixture containing polymer beads, a solvent and a salt can be used to solidify the gel (cf. European patent application EP 1 560 064 A1 and international application PCT WO 2004/085567 A2), whereby said mixture, once in place in the “reservoir” zone, is heated to form the transparent gel. This solution serves to obtain extremely viscous gels, containing less solvent.

However, it still remains difficult to fill the reservoir, and the system is liable to have mediocre optical transmission if the polymer beads are not perfectly solubilized and their refractive index is different from that of the rest of the gel.

International application PCT WO 02/040578, also describes a film of polyvinyl acetal, such as polyvinyl butyral, which can play the role of an electrolyte and lamination insert. However, this product requires formulation as an electrolyte before being shaped as an insert and is specifically designed to be effective with certain electrochromic materials, such as Prussian blue or tungsten oxide. Due to the lack of flexibility in the formulation, this product is liable to be far less effective, or even incompatible with other electroactive materials, such as PEDOT for example.

In attempting to solve all the above problems, the Applicant now proposes a novel and original solution, based on a self-supporting electrolyte system, suitable for imparting good contrast properties and easy to fabricate and use, and therefore suitable for all electrically-controllable devices, regardless of size.

The present invention therefore relates to an electrolyte material for an electrically-controllable device having variable optical/energy properties, characterized in that it comprises a self-supporting polymer matrix containing ionic fillers and a liquid for solubilizing said ionic fillers, said liquid not solubilizing said self-supporting polymer matrix, the latter being selected so as to provide a percolation path for said ionic fillers, the polymer or polymers of the polymer matrix being selected to withstand lamination and calendering conditions, optionally with heating.

The electrolyte material according to the invention is advantageously a transparent material.

The ionic fillers are carried by at least one ionic salt and/or at least one acid solubilized in said liquid and/or by said self-supporting polymer matrix.

The solubilizing liquid may consist of a solvent or a solvent mixture and/or of at least one ionic liquid or molten salt at ambient temperature, said ionic liquid or molten salt or said ionic liquids or molten salts thereby constituting a solubilizing liquid carrying ionic fillers, which represent all or part of the ionic fillers contained in said electrolyte material.

The ionic salt or salts may be selected from lithium perchlorate, trifluoromethanesulfonate or triflate salts, trifluoromethanesulfonylimide salts and ammonium salts.

The acid or acids may be selected from sulfuric acid (H₂SO₄), triflic acid (CF₃SO₃H), phosphoric acid (H₃PO₄) and polyphosphoric acid (Hₙ₊₂ Pₙ O₃ₙ₊₁). The concentration of the ionic salt or salts and/or of the acid or acids in the solvent or the solvent mixture is in particular lower than or equal to 5 moles/liter, preferably lower than or equal to 2 moles/liter, and even more preferably, lower than or equal to 1 mole/liter.

The or each solvent may be selected from those having a boiling point of at least 95° C., preferably at least 150° C.

The solvent or solvents may be selected from dimethylsulfoxide, N,N-dimethylformamide, N,N-dimethylacetamide, propylene carbonate, ethylene carbonate, N-methyl-2-pyrrolidone (1-methyl-2-pyrrolidinone), gamma-butyrolactone, ethylene glycols, alcohols, ketones, nitrites and water.

The ionic liquid or liquids may be selected from imidazolium salts, such as 1-ethyl-3-methylimidazolium tetrafluoroborate (emim-BF₄), 1-ethyl-3-methylimidazolium trifluoromethane sulfonate (emim-CF₃SO₃), 1-ethyl-3-methylimidazolium bis(trifluoromethylsulfonyl)imide (emim-N(CF₃SO₂)₂ or emim-TSFI) and 1-butyl-3-methylimidazolium bis(trifluoromethylsulfonyl)imide(bmim-N(CF₃SO₂)₂ or bmim-TSFI).

The self-supporting polymer matrix may consist of at least one polymer layer into which said liquid has completely penetrated.

The matrix polymer or polymers and the liquid may be selected so that the self-supporting active medium withstands a temperature corresponding to the temperature required for a subsequent lamination or calendering step, that is a temperature of at least 80° C., in particular at least 100° C.

The polymer constituting at least one layer may be a homo- or copolymer in the form of a film which is nonporous but capable of swelling in said liquid.

The film has in particular a thickness lower than 1000 μm, preferably between 100 and 800 μm, and more preferably between 100 and 700 μm.

The polymer constituting at least one layer may also be a homo- or copolymer in the form of a porous film, said porous film being optionally capable of swelling in the liquid comprising ionic fillers, and whereof the porosity after swelling is selected to permit the percolation of the ionic fillers into the thickness of the liquid-impregnated film.

Said film then has in particular a thickness lower than 1 mm, preferably lower than 1000 μm, more preferably between 100 and 800 μm, and even more preferably between 100 and 700 μm.

The polymer material constituting at least one layer may be selected from:

homo- or copolymers not comprising ionic fillers, in which case said fillers are carried by at least one ionic salt or solubilized acid and/or by at least one ionic liquid or molten salt;

homo- or copolymers comprising ionic fillers, in which case additional fillers for increasing the percolation rate can be carried by at least one ionic salt or solubilized acid and/or by at least one ionic liquid or molten salt; and

mixtures of at least one homo- or copolymer not carrying ionic fillers and at least one homo- or copolymer comprising ionic fillers, in which case additional fillers for increasing the percolation rate can be carried by at least one ionic salt or solubilized acid and/or by at least one ionic liquid or molten salt.

The polymer matrix may consist of a film based on a homo- or copolymer comprising ionic fillers, suitable for providing by itself a film essentially capable of providing the desired percolation rate for the ionic fillers or a higher percolation rate, and a homo- or copolymer comprising ionic fillers or not, suitable for providing by itself a film not necessarily providing the desired percolation rate but essentially capable of providing the mechanical strength, the contents of each of these two homo- or copolymers being adjusted so as to provide both the desired percolation rate and the mechanical strength of the resulting self-supporting matrix.

The polymer or polymers of the polymer matrix not comprising ionic fillers may be selected from copolymers of ethylene, vinyl acetate and optionally at least one other comonomer, such as ethylene-vinyl acetate copolymers (EVA); polyurethane (PU); polyvinyl butyral (PVB); polyimides (PI); polyamides (PA); polystyrene (PS); polyvinylidene fluoride (PVDF); polyether-ether-ketones (PEEK); polyethylene oxide (PEO); copolymers of epichlorohydrin and polymethyl methacrylate (PMMA).

The polymers are selected from the same family whether they are prepared in the form of porous or nonporous films, the porosity being provided by the porogenic agent used during the fabrication of the film.

As preferred polymers in the case of the nonporous film, mention can be made of polyurethane (PU), or ethylene-vinyl acetate (EVA) copolymers.

As preferred polymers in the case of the porous film, mention can be made of polyvinylidene fluoride.

The polymer or polymers of the polymer matrix carrying ionic fillers or polyelectrolytes may be selected from sulfonated polymers which have undergone an exchange of H⁺ ions of the SO₃H groups with the ions of the ionic fillers desired, said ion exchange having taken place before and/or simultaneously with the swelling of the polyelectrolyte in the liquid comprising ionic fillers.

The sulfonated polymer may be selected from sulfonated copolymers of tetrafluoroethylene, sulfonated polystyrenes (PSS), sulfonated polystyrene copolymers, poly (2-acrylamido-2-methyl-1-propanesulfonic acid) (PAMPS), sulfonated polyetheretherketones (PEEK) and sulfonated polyimides.

The self-supporting polymer matrix may comprise one to three layers. It has in particular a thickness lower than 1000 μm, preferably between 100 and 800 μm, and more preferably between 100 and 700 μm.

When the support comprises at least two layers, a stack of at least two layers may be formed from electrolyte and/or non-electrolyte polymer layers before complete penetration of the liquid, and has then been swelled by said liquid.

When the support comprises three layers, the two outer layers of the stack may be low-swelling layers to promote the mechanical strength of said material and the central layer is a high-swelling layer to promote the percolation rate of the ionic fillers.

The electrolyte material according to the invention advantageously has a conductivity ≧10⁻⁴ S/cm.

The self-supporting polymer matrix may be nanostructured by the incorporation of nanoparticles of inorganic fillers or nanoparticles, in particular of SiO₂ nanoparticles, at the rate in particular of a few percent of the mass of polymer in the support. This serves to improve certain properties of said support such as the mechanical strength.

The present invention also relates to a method for fabricating an electrolyte material as defined above, characterized in that polymer granules are mixed with a solvent and, if a porous polymer matrix is to be fabricated, a porogenic agent, the resulting blend is poured on a support and, after the solvent has evaporated, the porogenic agent is removed by washing in a suitable solvent, for example, if said agent has not been removed during the evaporation of the abovementioned solvent, the resulting self-supporting film is removed, said film is then impregnated with liquid for solubilizing said ionic fillers, followed by drainage, if applicable.

The immersion can be carried out during a time interval of 2 minutes to 3 hours. The immersion can be carried out with heating, for example at a temperature of 40 to 80° C.

The immersion can also be carried out with the application of ultrasound to assist the penetration of the solubilizing liquid into the matrix.

The present invention also relates to a kit for fabricating the electroactive material, characterized in that it consists of:

a self-supporting polymer matrix as defined above; and

a liquid for solubilizing ionic fillers as defined above, in which said ionic fillers have been solubilized.

The present invention also relates to an electrically-controllable device having variable optical/energy properties, comprising an electrolyte material as described above.

In particular, said electrically-controllable device comprises the following succession of layers:

a first substrate having a glass function;

a first electronically conductive layer with associated current input;

a first layer of electroactive material, reservoir of ionic fillers, responding to a current;

said electrolyte material;

a second layer of electroactive material, reservoir of ionic fillers, responding to a current;

a second electronically conductive layer with associated current input; and

a second substrate having a glass function, at least one of the two layers of electroactive material being electrochromic, capable of changing color under the effect of an electric current, and the ionic fillers of the electrolyte material being inserted into one of the layers of electroactive material and being stripped from the other layer of electroactive material, upon the application of a current to obtain a color contrast between the two layers of electroactive material.

The substrates having a glass function are in particular selected from glass (such as float glass, etc.) and transparent polymers, such as polymethyl methacrylate (PMMA), polycarbonate (PC), polyethylene terephthalate (PET), polyethylene naphthoate (PEN) and cycloolefin copolymers (COC).

The electronically conductive layers are in particular metal layers, such as layers of silver, gold, platinum and copper; or transparent conductive oxide (TCO) layers, such as layers of tin-doped indium oxide (In₂O₃:Sn or ITO), antimony-doped indium oxide (In₂O₃:Sb), fluorine-doped tin oxide (SnO₂:F) and aluminum-doped zinc oxide (ZnO:Al); or multilayers of the TCO/metal/TCO type, the TCO and the metal being selected in particular from those listed above; or multilayers of the NiCr/metal/NiCr type, the metal being selected in particular from those listed above.

When the electrochromic system is intended to operate by transmission, the electronically conductive materials are generally transparent oxides of which the electronic conduction has been amplified by doping such as In₂O₃:Sn, In₂O₃:Sb, ZnO:Al or SnO₂:F. Tin-doped indium oxide (In₂O₃:Sn or ITO) is frequently selected for its high electronic conductivity properties and its low light absorption. When the system is intended to operate by reflection, one of the electronically conductive materials may be a metal.

The two layers of electroactive material may be identical layers of electrochromic material. The two layers of electrochromic electroactive material may be different, in particular having a complementary coloration, one of them having an anodic coloration, and the other having a cathodic coloration. According to another alternative, one of the layers of electroactive material is an electrochromic layer and the other layer of electroactive material is not electrochromic, only playing the role of a reservoir of ionic fillers or a counter-electrode.

The electrochromic material or materials may be selected from:

(1) inorganic materials, such as oxides of tungsten, nickel, iridium, niobium, tin, bismuth, vanadium, nickel, antimony and tantalum, individually or in a mixture of two of them or more; if applicable in a mixture with at least one additional metal, such as titanium, tantalum or rhenium;

(2) organic materials, such as electronically conductive polymers, like derivatives of polythiophene, polypyrrole or polyaniline;

(3) complexes, such as Prussian blue;

(4) metallopolymers;

(5) combinations of at least two electrochromic materials selected from at least two families (1) to (4).

One of the most widely used and most investigated electrochromic materials is tungsten oxide, which goes from a blue coloration to a transparent coloration according to its state of insertion of the fillers. It is an electrochromic material with cathodic coloration, that is its colored state corresponds to the inserted (or reduced) state and its decolored state corresponds to the deinserted (or oxidized) state. During the construction of an electrochromic system with five layers, it is customary to combine it with an electrochromic material with an anodic coloration such as nickel oxide or iridium oxide, of which the coloration mechanism is complementary. The light contrast of the system is thereby amplified. All the materials mentioned above are inorganic, but it is also possible to combine complexes with the inorganic electrochromic materials, such as Prussian blue or metallopolymers, or even organic materials such as electronically conductive polymers (derivatives of polythiophene, polypyrrole, or polyaniline, etc.), or even to use only one category of these materials.

The non-electrochromic electroactive material may be an optically neutral material in the oxidation states concerned, such as vanadium oxide, the counter-electrode also optionally consisting of a fine layer of silver or a fine layer of carbon, highly conductive. To increase their transparency, these materials may be nanostructured.

The electrically-controllable device of the present invention is configured in particular to form:

a roof for motor vehicle, independently activable, or a side window or a rear window for motor vehicle or a rear view mirror;

a windshield or a portion of windshield of a motor vehicle, an aircraft or a ship, an automobile roof;

an aircraft window;

a display panel for graphic and/or alphanumeric information;

an indoor or outdoor glazing of a building;

a roof window;

a showcase, store counter;

a protective glazing for an object such as a picture;

a computer anti-glare screen;

glass furniture;

a partition wall between two rooms in a building.

The electrically-controllable device operates by transmission or by reflection.

The substrates may be transparent, flat or convex, clear or body-tinted, opaque or opacified, having a polygonal or at least partially curved shape. At least one of the substrates may incorporate another function, such as a solar control, anti-glare or self-cleaning function.

The present invention also relates to a method for fabricating the electrically-controllable device characterized in that the various layers thereof are assembled by calendering or lamination, optionally with heating.

In the case in which said electrically-controllable device is intended to constitute a glazing, the above method also comprises the assembly of the various layers in a single or multiple glazing.

The present invention also relates to a single or multiple glazing, characterized in that it comprises an electrically-controllable device as described above.

The following examples illustrate the present invention but without limiting its scope. In these examples, the following abbreviations have been used:

PU: polyurethane

PC: propylene carbonate

EVA: ethylene-vinyl acetate copolymer

NMP: N-methyl-2-pyrrolidone

PEDOT: poly(3,4-ethylenedioxythiophene)

PSS: polystyrene sulfonate

PVDF: polyvinylidene fluoride

The PEDOT/PSS used in the example is sold by Bayer under the trade name Baytron®.

Use was made of a PU resin or PU film sold by Huntsman, Argotec, Noveon, Polymar, Deerfield Urethane or even Stevens Urethane.

Use was made of an EVA film sold by Bridgestone, Dupont, Takemeruto, Sekisui, Tosoh.

Use was made of the PVDF powder sold by Arkema under the trade name Kynar®, Kynarflex® or Powerflex®.

The glass used in these examples is a glass provided with an electronically conductive layer with SnO₂:F or ITO.

The polyethylene oxide used in the Comparative Example is sold by Dai Ichi Kogyo Seiyaku under the trade name Elexcel®.

### Example 1

### Preparation of a Self-supporting Electrolyte Film of the Invention

In order to check that PC was capable of swelling the film of PU 100 microns thick, swelling tests were performed. Five samples of PU were previously weighed, and then immersed in PC for one hour at 20° C. The films were then reweighed after simple drainage, and after having been wiped on paper. The measurements taken on the simply drained films revealed a weight gain of between 62% and 68%. The measurements taken on the wiped films revealed a weight gain of between 18% and 21%. It therefore clearly appears that not only was the PC adsorbed on the PU surface, but also penetrated deeply into the film.

A self-supporting electrolyte film was obtained by impregnating a 5×5 cm² of a PU film 100 microns thick in a solution containing 0.5 M of lithium perchlorate in PC.

The self-supporting electrolyte film was removed from the solution of lithium perchlorate in PC after one hour of impregnation at 20° C. and was then drained.

### Example 2

### Preparation of a Self-supporting Electrolyte Film of the Invention

A PVDF film was obtained by pouring an acetone solution containing 15% by weight of Kynarflex® 2751, 30% by weight of dibutyl phthalate and 12% by weight of silica on a glass plate.

The film was detached from the glass plate under a stream of water. After drying, the film had a thickness of about 40 microns.

The PVDF film was then washed for 30 minutes with ether and then impregnated for 5 minutes in a solution containing 0.5 M of lithium perchlorate in PC.

### Example 3

### Preparation of a Self-supporting Electrolyte Film of the Invention

In order to check that NMP was capable of swelling the film of EVA 200 microns thick, swelling tests were performed. Five samples of EVA were previously weighed, and then immersed in NMP for one hour at 20° C. The films were then reweighed after simple drainage, and after having been wiped on paper. The measurements taken on the simply drained films revealed a weight gain of between 70% and 78%. The measurements taken on the wiped films revealed a weight gain of between 41% and 42%. It therefore clearly appears that not only was the NMP adsorbed on the EVA surface, but also penetrated deeply into the film.

A self-supporting electrolyte film was obtained by impregnating a 5×5 cm² of a EVA film 200 microns thick in a solution containing 0.25 M of lithium perchlorate in NMP.

The self-supporting electrolyte film was removed from the solution of lithium perchlorate in NMP after one hour of impregnation at 20° C. and was then drained.

### Example 4

### Fabrication of an Electrochromic Cell With the Electrolyte Film of Example 1 and PEDOT/PSS

An electrochromic cell was then prepared using the self-supporting electrolyte film of Example 1. Two deposits of PEDOT/PSS were obtained by pouring on two K-glass glasses.

Once the PEDOT/PSS deposits were dry, one of the two plates was reduced in a solution containing 1 M of lithium perchlorate in acetonitrile. After reduction, the K-glass covered with a layer of reduced PEDOT/PSS was washed with ethanol and dried by blowing.

The drained electrolyte film was then deposited on K-glass glass covered with PEDOT/PSS (unreduced plate). A two-sided adhesive was placed around the electrolyte. The K-glass glass covered with the reduced PEDOT/PSS was then placed above the electrolyte film, in order to complete the cell.

The cell was then autoclaved at 95° C., and the periphery of the electrochromic cell was surrounded with epoxy adhesive playing the role of encapsulation and serving to reinforce the cohesion between the two glass substrates and the electrolyte film.

The electrochromic cell thus fabricated had a light transmission of 37% in the decolored state, in short-circuit, and 19% after 2 minutes at 2V.

### Example 5

### Fabrication of an Electrochromic Cell With the Electrolyte Film of Example 2 and PEDOT/PSS

An electrochromic cell was prepared using the self-supporting electrolyte film of Example 2 and precisely following the same procedure as described in Example 4.

The electrochromic cell thus fabricated had a light transmission of 38% in the decolored state, in short-circuit, and 19% after 2 minutes at 2V.

### Example 6 (comparative)

### Fabrication of an Electrochromic Cell With Gel Based Electrolyte and PEDOT/PSS

For the purpose of comparison, an electrochromic cell was fabricated following the procedure described above, but with a polymeric gel electrolyte.

In this cell, the electrolyte was a gel comprising 60% by weight of a polyethylene oxide based resin, 36% by weight of 1-ethyl-3-methylimidazolium bis(trifluoromethylsulfonyl)imide and 4% by weight of lithium bis(trifluoromethylsulfonyl)imide. This gel was deposited using an applicator in a thickness of 100 microns.

The electrochromic cell thus fabricated had a light transmission of 31% in the decolored state, in short-circuit, and 20% after 2 minutes at 2V.

### Example 7

### Fabrication of an Electrochromic Cell With the Electrolyte Film of Example 1 and Inorganic Electrochromic Layers

An electrochromic cell was then prepared using the self-supporting electrolyte film of Example 1. The electrochromic layer and the counter-electrode layer were layers of tungsten oxide and iridium oxide respectively obtained by magnetron sputtering on glass coated with a conductive layer of ITO.

The drained electrolyte film was then deposited on one of the two substrates. The cell was then closed using the other substrate and sealed with a two-sided adhesive.

The cell was then autoclaved at 95° C., and the periphery of the electrochromic cell was surrounded with epoxy adhesive playing the role of encapsulation and serving to reinforce the cohesion between the two glass substrates and the electrolyte film.

The electrochromic cell thus fabricated had a light transmission of 55% in the decolored state, after 2 minutes at 1V, and 24%, after 2 minutes at −1.5V.

### Example 8

### Fabrication of an Electrochromic Cell With the Electrolyte Film of Example 3 and PEDOT/PSS

An electrochromic cell was then prepared using the self-supporting electrolyte film of Example 3. Two deposits of PEDOT/PSS were prepared and used as described in Example 4. The drained electrolyte film was deposited on K-glass glass covered with PEDOT/PSS (unreduced plate). A two-sided adhesive was then placed around the electrolyte and the K-glass glass covered with the reduced PEDOT/PSS layer was placed above the electrolyte film, in order to complete the cell.

The cell was then heated to 80° C., and the periphery of the electrochromic cell was surrounded with epoxy adhesive playing the role of encapsulation and serving to reinforce the cohesion between the two glass substrates and the electrolyte film.

The electrochromic cell thus fabricated had a light transmission of 40% in the decolored state, in short-circuit, and 25% after 2 minutes at 2V.

1. An electrolyte material for an electrically-controllable device having variable optical/energy properties, comprising a self-supporting polymer matrix containing ionic fillers and a liquid for solubilizing said ionic fillers while not solubilizing said self-supporting polymer matrix, said liquid being selected so as to provide a percolation path for said ionic fillers, the polymer or polymers of the polymer matrix being selected to withstand lamination and calendering conditions, optionally with heating.

2. The electrolyte material as claimed in claim 1, wherein the ionic fillers are carried by at least one ionic salt and/or at least one acid solubilized in said liquid and/or by said self-supporting polymer matrix.

3. The electrolyte material as claimed in claim 1, wherein the solubilizing liquid comprises a solvent or a solvent mixture and/or of at least one ionic liquid or molten salt at ambient temperature, said ionic liquid or molten salt or said ionic liquids or molten salts thereby constituting a solubilizing liquid carrying ionic fillers, which represent all or part of the ionic fillers contained in said electrolyte material.

4. The electrolyte material as claimed in claim 2, wherein the ionic salt or salts are selected from lithium perchlorate, trifluoromethanesulfonates or triflate salts, trifluoromethanesulfonylimide salts and ammonium salts.

5. The electrolyte material as claimed in claim 2, wherein the acid or acids are selected from sulfuric acid (H₂SO₄), triflic acid (CF₃SO₃H), phosphoric acid (H₃PO₄) and polyphosphoric acid (Hₙ₊₂ Pₙ O₃ₙ₊₁).

6. The electrolyte material as claimed in claim 3, wherein the solvent or solvents are selected from dimethylsulfoxide, N,N-dimethylformamide, N,N-dimethylacetamide, propylene carbonate, ethylene carbonate, N-methyl-2-pyrrolidone (1-methyl-2-pyrrolidinone), gamma-butyrolactone, ethylene glycols, alcohols, ketones, nitrites and water.

7. The electrolyte material as claimed in claim 3, wherein the ionic liquid or liquids are selected from imidazolium salts, selected from the group consisting of 1-ethyl-3-methylimidazolium tetrafluoroborate (emim-BF₄), 1-ethyl-3-methylimidazolium trifluoromethane sulfonate (emim-CF₃SO₃), 1-ethyl-3-methylimidazolium bis(trifluoromethylsulfonyl)imide (emim-N(CF₃SO₂)₂ or emim-TSFI) and 1-butyl-3-methylimidazolium bis(trifluoromethylsulfonyl)imide(bmim-N(CF₃SO₂)₂ or bmim-TSFI).

8. The electrolyte material as claimed in claim 1, wherein the self-supporting polymer matrix comprises at least one polymer layer into which said liquid has completely penetrated.

9. The electrolyte material as claimed in claim 8, wherein the polymer constituting at least one layer is a homo- or copolymer in the form of a film which is nonporous but capable of swelling in said liquid.

10. The electroactive material as claimed in claim 8, wherein the polymer constituting at least one layer is a homo- or copolymer in the form of a porous film, said porous film being optionally capable of swelling in the liquid comprising ionic fillers, and whereof the porosity after swelling is selected to permit the percolation of the ionic fillers into the thickness of the liquid-impregnated film.

11. The electrolyte material as claimed in claim 8, wherein the polymer material constituting at least one layer is selected from:
homo- or copolymers not comprising ionic fillers, in which case said fillers are carried by at least one ionic salt or solubilized acid and/or by at least one ionic liquid or molten salt;
homo- or copolymers comprising ionic fillers, in which case additional fillers for increasing the percolation rate can be carried by at least one ionic salt or solubilized acid and/or by at least one ionic liquid or molten salt; and
mixtures of at least one homo- or copolymer not carrying ionic fillers and at least one homo- or copolymer comprising ionic fillers, in which case additional fillers for increasing the percolation rate can be carried by at least one ionic salt or solubilized acid and/or by at least one ionic liquid or molten salt.

12. The electrolyte material as claimed in claim 1, wherein said polymer matrix comprises a film based on a homo- or copolymer comprising ionic fillers, suitable for providing by itself a film essentially capable of providing the desired percolation rate for the ionic fillers or a higher percolation rate, and a homo- or copolymer comprising ionic fillers or not, suitable for providing by itself a film not necessarily providing the desired percolation rate but essentially capable of providing the mechanical strength, the contents of each of these two homo- or copolymers being adjusted so as to provide both the desired percolation rate and the mechanical strength of the resulting self-supporting matrix.

13. The electrolyte material as claimed in claim 11, wherein the polymer or polymers of the polymer matrix not comprising ionic fillers are selected from copolymers of ethylene, vinyl acetate and optionally at least one other comonomer, selected from the group consisting of ethylene-vinyl acetate copolymers (EVA); polyurethane (PU); polyvinyl butyral (PVB); polyimides (PI); polyamides (PA); polystyrene (PS); polyvinylidene fluoride (PVDF); polyether-ether-ketones (PEEK); polyethylene oxide (PEO); and copolymers of epichlorohydrin and polymethyl methacrylate (PMMA).

14. The electrolyte material as claimed in claim 1, wherein the polymer or polymers of the polymer matrix carrying ionic fillers or polyelectrolytes are selected from sulfonated polymers which have undergone an exchange of H⁺ ions of the SO₃H groups with the ions of the ionic fillers desired, said ion exchange having taken place before and/or simultaneously with the swelling of the polyelectrolyte in the liquid comprising ionic fillers.

15. The electrolyte material as claimed in claim 14, wherein the sulfonated polymer is selected from sulfonated copolymers of tetrafluoroethylene, sulfonated polystyrenes (PSS), sulfonated polystyrene copolymers, poly(2-acrylamido-2-methyl-1-propanesulfonic acid) (PAMPS), sulfonated polyetheretherketones (PEEK) and sulfonated polyimides.

16. The electrolyte material as claimed in claim 1, wherein the self-supporting polymer matrix comprises one to three layers.

17. The electrolyte material as claimed in claim 1, in which the self-supporting polymer matrix comprises at least two layers, wherein a stack of at least two layers has been formed from electrolyte and/or non-electrolyte polymer layers before complete penetration of the liquid, and has then been swelled by said liquid.

18. The electrolyte material as claimed in claim 1, in which the support comprises three layers, wherein the two outer layers of the stack are low-swelling layers to promote the mechanical strength of said material and the central layer is a high-swelling layer to promote the percolation rate of the ionic fillers.

19. The electrolyte material as claimed in claim 1, wherein the self-supporting polymer matrix has a thickness lower than 1000 μm.

20. The electrolyte material as claimed in claim 1, wherein it has a conductivity ≧10⁻⁴ S/cm.

21. The electrolyte material as claimed in claim 1, wherein the self-supporting polymer matrix is nanostructured by the incorporation of nanoparticles of inorganic fillers SiO₂ nanoparticles.

22. A method for fabricating an electrolyte material as claimed in claim 1, wherein polymer granules are mixed with a solvent and, if a porous polymer matrix is to be fabricated, a porogenic agent, the resulting blend is poured onto a support and, after the solvent has evaporated, the porogenic agent is removed by washing in a suitable solvent if said agent has not been removed during the evaporation of the solvent, the resulting self-supporting film is removed from the support, and said film is then impregnated with liquid for solubilizing said ionic fillers, followed optionally by drainage.

23. A kit for fabricating the electrolyte material as claimed in claim 1, comprising:
a self-supporting polymer matrix containing ionic fillers; and
a liquid for solubilizing said ionic fillers.

24. An electrically-controllable device having variable optical/energy properties, comprising an electrolyte material as claimed in claim 1.

25. The electrically-controllable device as claimed in claim 24, wherein it comprises the following succession of layers:
a first substrate having a glass function;
a first electronically conductive layer with associated current input;
a first layer of electroactive material, reservoir of ionic fillers, responding to a current;
said electrolyte material;
a second layer of electroactive material, reservoir of ionic fillers, responding to a current;
a second electronically conductive layer with associated current input; and
a second substrate having a glass function, at least one of the two layers of electroactive material being electrochromic, capable of changing color under the effect of an electric current, and the ionic fillers of the electrolyte material being inserted into one of the layers of electroactive material and being stripped from the other layer of electroactive material, upon the application of a current to obtain a color contrast between the two layers of electroactive material.

26. The electrically-controllable device as claimed in claim 25, wherein the substrates having a glass function are selected from glass and transparent polymers, selected from the group consisting of polymethyl methacrylate (PMMA), polycarbonate (PC), polyethylene terephthalate (PET), polyethylene naphthoate (PEN) and cycloolefin copolymers (COC).

27. The electrically-controllable device as claimed in claim 25, wherein the electronically conductive layers are metal layers, selected from the group consisting of silver, gold, platinum and copper; or transparent conductive oxide (TCO) layers selected from the group consisting of tin-doped indium oxide (In₂O₃:Sn or ITO), antimony-doped indium oxide (In₂O₃:Sb), fluorine-doped tin oxide (SnO₂:F) and aluminum-doped zinc oxide (ZnO:Al); or multilayers of the TCO/metal/TCO type, the TCO and the metal being selected in particular from those listed above; or multilayers of the NiCᵣ/metal/NiCᵣ type, the metal being selected in particular from those listed above.

28. The electrically-controllable device as claimed in claim 25, wherein the two layers of electroactive material are identical layers of electrochromic material.

29. The electrically-controllable device as claimed in claim 25, wherein the two layers of electrochromic electroactive material are different having a complementary coloration, one of them having an anodic coloration, and the other having a cathodic coloration.

30. The electrically-controllable device as claimed in claim 25, wherein one of the layers of electroactive material is an electrochromic layer and the other layer of electroactive material is not electrochromic, only playing the role of a reservoir of ionic fillers or a counter-electrode.

31. The electrically-controllable device as claimed in claim 25, wherein the electrochromic material or materials are selected from:
(1) inorganic materials, selected from oxides of tungsten, nickel, iridium, niobium, tin, bismuth, vanadium, nickel, antimony and tantalum, individually or in a mixture of two of them or more; optionally in a mixture with at least one additional metal selected from titanium, tantalum or rhenium;
(2) organic materials selected from electronically conductive polymers of polythiophene, polypyrrole and polyaniline;
(3) complexes;
(4) metallopolymers; and
(5) combinations of at least two electrochromic materials selected from at least two families (1) to (4).

32. The electrically-controllable device as claimed in claim 30, wherein the non-electrochromic electroactive material is an optically neutral material in the oxidation states concerned, the counter-electrode also optionally consisting of a fine layer of silver or a fine layer of carbon, these highly conductive materials optionally being nanostructured to increase their transparency.

33. The electrically-controllable device as claimed in claim 25, wherein it is configured in the form of:
a roof for motor vehicle, independently activable, or a side window or a rear window for motor vehicle or a rear view mirror;
a windshield or a portion of windshield of a motor vehicle, an aircraft or a ship, an automobile roof;
an aircraft window;
a display panel for graphic and/or alphanumeric information;
an indoor or outdoor glazing of a building;
a roof window;
a showcase or store counter;
a protective glazing for an object or a picture;
a computer anti-glare screen;
glass furniture; and
a partition wall between two rooms in a building.

34. The electrically-controllable device as claimed in claim 25, wherein it operates by transmission or by reflection.

35. The electrically-controllable device as claimed in claim 25, wherein the substrates are transparent, flat or convex, clear or body-tinted, opaque or opacified, having a polygonal or at least partially curved shape.

36. The electrically-controllable device as claimed in claim 25, wherein at least one of the substrates incorporates another function selected from a solar control, anti-glare or self-cleaning function.

37. A method for fabricating the electrically-controllable device as claimed in claim 25, wherein the various layers thereof are assembled by calendering or lamination, optionally with heating.

38. The method as claimed in claim 37, in which the electrically-controllable device is intended to constitute a glazing, wherein the various layers are mounted as a single or multiple glazing.

39. A single or multiple glazing, wherein it comprises an electrically-controllable device as claimed in claim 25.
